(19) United States
(12) Patent Application Publication
(10) Pub. No.: US 2015/0042557 A1
(43) Pub. Date: Feb. 12, 2015

(54) INFORMATION PROCESSING APPARATUS, INFORMATION PROCESSING METHOD, AND PROGRAM

(71) Applicant: Sony Corporation, Tokyo (JP)

(72) Inventors: Tomoya Narita, Kanagawa (JP); Yousuke Kawana, Tokyo (JP); Lyo Takaoka, Tokyo (JP); Daisuke Hiro, Kanagawa (JP); Akane Yano, Tokyo (JP)

(73) Assignee: Sony Corporation, Tokyo (JP)

(21) Appl. No.: 14/381,804

(22) PCT Filed: Jan. 15, 2013
(86) PCT No.: PCT/JP2013/050556

§ 371 Date: Aug. 28, 2014

(30) Foreign Application Priority Data
Mar. 7, 2012 (JP) 2012-050270

(51) Int. Cl. G06F 3/01; H04N 13/04

(52) U.S. Cl. CPC G06F 3/013; H04N 13/0484
USPC 345/156

(57) ABSTRACT

There is provided an information processing apparatus including a viewpoint position determination unit that determines, based on acquired viewpoint position information regarding a viewpoint position of a user, whether the viewpoint position of the user is included in a viewpoint position range suitable for content, and an object display control unit that, if the viewpoint position of the user is not included in the viewpoint position range suitable for the content, performs display control for displaying a viewpoint guidance object that guides the viewpoint of the user to the viewpoint position range suitable for the content.

### TECHNICAL FIELD

The present disclosure relates to an information processing apparatus, an information processing method, and a program.

### BACKGROUND ART

In recent years, displays which make it possible for a user to sense objects stereoscopically by utilizing human binocular parallax have been developed. Among such stereoscopic displays, there are many in which the viewpoint position when gazing at the display is restricted (For example, refer to Patent Document 1 below.).

In particular, in a browsing method like that called phantogram, in which stereoscopic 3D display is not performed from the front of the screen, but browsing is performed by offsetting the viewpoint position, since the stereoscopic feel is enhanced only when content is gazed at from a certain specific position, the viewpoint position of the user becomes an important factor.

### CITATION LIST

### Patent Literature

Patent Literature 1: JP 2012-10086A

### SUMMARY OF INVENTION

### Technical Problem

In stereoscopic content like that mentioned above, when browsing of the content is performed other than at a specific viewpoint position, various browsing loads can arise such as crosstalk occurs, objects appear distorted, and images of the display objects are unable to be formed.

With respect to this, techniques also exist in which stereoscopic viewing is restricted, stereoscopic viewing is stopped, or content is corrected so that stereoscopic viewing is possible when browsing of content is performed other than at the specific viewpoint position. However, the operational load on the user increases, as well as there is the necessity of designing so as to adapt the content itself to such a browsing format, and thus the load on the content creator also increases.

Also, in content generated by computer graphics or the like, by representations such as desktop virtual reality (Desktop VR) or fishtank virtual reality (Fishtank VR), it is possible to generate a display field of view at any viewpoint position. However, it is difficult to apply such a technique to a picked up video image or special content that has meaning from only a specific viewpoint.

Thus, the present invention, taking into consideration the above-mentioned circumstances, proposes an information processing apparatus, an information processing method, and a program for which guidance of the viewpoint of the user to a preferable viewpoint range while suppressing the operational load on the user is possible.

According to the present disclosure, there is provided an information processing apparatus including a viewpoint position determination unit that determines, based on acquired viewpoint position information regarding a viewpoint position of a user, whether the viewpoint position of the user is included in a viewpoint position range suitable for content, and an object display control unit that, if the viewpoint position of the user is not included in the viewpoint position range suitable for the content, performs display control for displaying a viewpoint guidance object that guides the viewpoint of the user to the viewpoint position range suitable for the content.

According to the present disclosure, there is provided an information processing method including determining, based on acquired viewpoint position information regarding a viewpoint position of a user, whether the viewpoint position of the user is included in a viewpoint position range suitable for content, and if the viewpoint position of the user is not included in the viewpoint position range suitable for the content, performing display control for displaying a viewpoint position guidance object that guides the viewpoint of the user to the viewpoint position range suitable for the content.

According to the present disclosure, there is provided a program for causing a computer to realize a viewpoint position determination function that determines, based on acquired viewpoint position information regarding a viewpoint position of a user, whether the viewpoint position of the user is included in a viewpoint position range suitable for content, and an object display control function that, if the viewpoint position of the user is not included in the viewpoint position range suitable for the content, performs display control for displaying a viewpoint position guidance object that guides the viewpoint of the user to the viewpoint position range suitable for the content.

### Solution to Problem

According to the present disclosure, based on viewpoint position information regarding the viewpoint position of the user, it is determined whether the viewpoint position of the user is included in the viewpoint position range suitable for the content, and, if the viewpoint position of the user is not included in the viewpoint position range suitable for the content, display control for displaying a viewpoint position guidance object that guides the viewpoint of the user to the viewpoint position range suitable for the content is executed.

### Advantageous Effects of Invention

According to the present disclosure as explained above, guidance of the viewpoint of the user to a preferable range while suppressing the operational load on the user becomes possible.

### BRIEF DESCRIPTION OF DRAWINGS

FIG. 1A is an explanatory diagram showing one example of stereoscopic content.

FIG. 1B is an explanatory diagram showing one example of stereoscopic content.

FIG. 1C is an explanatory diagram showing one example of stereoscopic content.

FIG. 2 is a block diagram showing the configuration of an information processing apparatus according to an embodiment of the present disclosure.

FIG. 3 is a block diagram showing the configuration of the control unit included in the information processing apparatus according to an embodiment of the present disclosure.

FIG. 4 is an explanatory diagram showing one example of the relationship between the holding state of the information processing apparatus and the viewpoint position.

FIG. 5 is an explanatory diagram showing one example of the coordinate system used in the present disclosure.

FIG. 6 is a block diagram showing the configuration of the user viewpoint position specification unit included in the control unit according to a first embodiment of the present disclosure.

FIG. 7A is an explanatory diagram showing an angle representing the holding state of the information processing apparatus.

FIG. 7B is an explanatory diagram showing an angle representing the holding state of the information processing apparatus.

FIG. 8 is an explanatory diagram showing one example of a profile according to the same embodiment.

FIG. 9 is an explanatory diagram for explaining about the viewpoint position of the user.

FIG. 10A is an explanatory diagram for explaining a profile according to the same embodiment.

FIG. 10B is an explanatory diagram for explaining a profile according to the same embodiment.

FIG. 10C is an explanatory diagram for explaining a profile according to the same embodiment.

FIG. 11A is an explanatory diagram for explaining a profile according to the same embodiment.

FIG. 11B is an explanatory diagram for explaining a profile according to the same embodiment.

FIG. 11C is an explanatory diagram for explaining a profile according to the same embodiment.

FIG. 12A is an explanatory diagram for explaining a profile according to the same embodiment.

FIG. 12B is an explanatory diagram for explaining a profile according to the same embodiment.

FIG. 12C is an explanatory diagram for explaining a profile according to the same embodiment.

FIG. 13 is an explanatory diagram for explaining about the estimation process of the viewpoint position when used together with a picked up image.

FIG. 14 is a flowchart showing one example of the flow of the information processing method according to the same embodiment.

FIG. 15 is a block diagram showing the configuration of the display control unit included in the information processing apparatus according to a second embodiment of the present disclosure.

FIG. 16 is an explanatory diagram showing display control in the information processing apparatus according to the same embodiment.

FIG. 17A is an explanatory diagram showing one example of a viewpoint guidance object according to the same embodiment.

FIG. 17B is an explanatory diagram showing one example of a viewpoint guidance object according to the same embodiment.

FIG. 18A is an explanatory diagram showing one example of a viewpoint guidance object according to the same embodiment.

FIG. 18B is an explanatory diagram showing one example of a viewpoint guidance object according to the same embodiment.

FIG. 19A is an explanatory diagram showing one example of a viewpoint guidance object according to the same embodiment.

FIG. 19B is an explanatory diagram showing one example of a viewpoint guidance object according to the same embodiment.

FIG. 20A is an explanatory diagram showing one example of a viewpoint guidance object according to the same embodiment.

FIG. 20B is an explanatory diagram showing one example of a viewpoint guidance object according to the same embodiment.

FIG. 21A is an explanatory diagram showing one example of a viewpoint guidance object according to the same embodiment.

FIG. 21B is an explanatory diagram showing one example of a viewpoint guidance object according to the same embodiment.

FIG. 22 is a flowchart showing one example of the flow of the information processing method according to the same embodiment.

FIG. 23 is a block diagram showing one example of the hardware configuration of the information processing apparatus according to an embodiment of the present disclosure.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

Explanation is performed in the following order.

(1) Regarding one example of stereoscopic content

(2) First embodiment
(2-1) Regarding the configuration of the information processing apparatus
(2-2) Regarding the configuration of the user viewpoint position specification unit
(2-3) Regarding the information processing method (estimation method of the viewpoint position of the user)

(3) Second embodiment
(3-1) Regarding the configuration of the display control unit
(3-2) Regarding the information processing method (display control method)

(4) Regarding the hardware configuration of the information processing apparatus according to each embodiment of the present disclosure.

### (Regarding One Example of Stereoscopic Content)

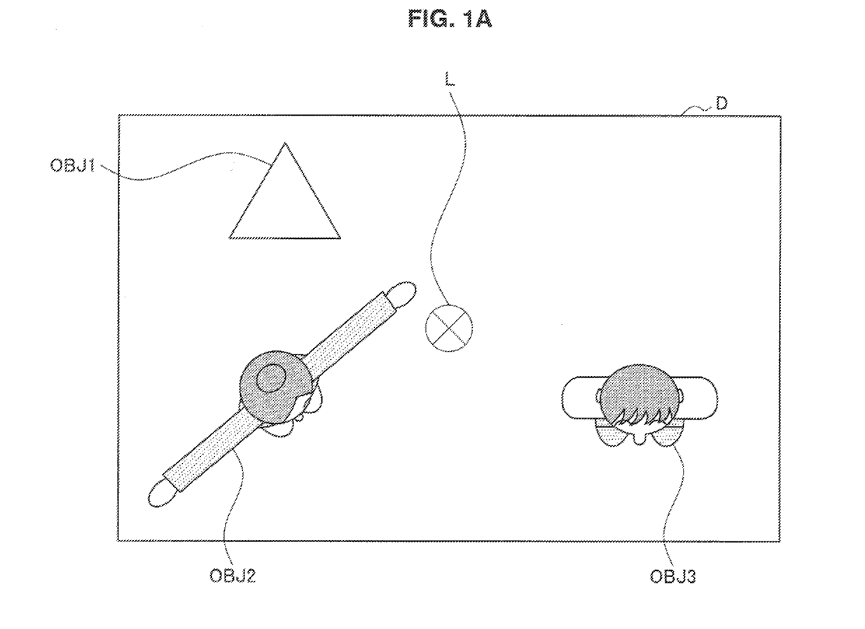

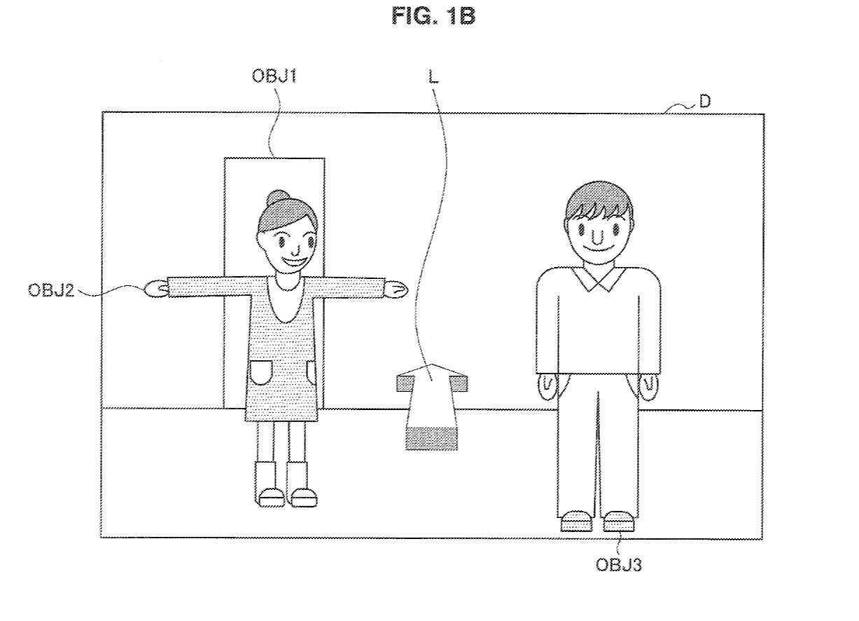

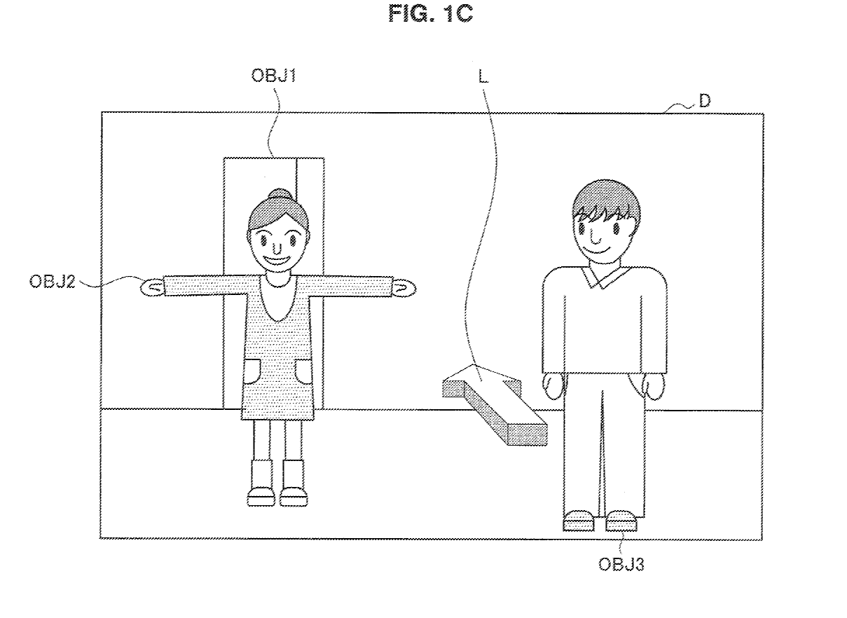

Before explaining about the information processing apparatuses according to the embodiments of the present disclosure, one example of stereoscopic content executed by the information processing inventions according to the embodiments of the present disclosure is simply explained with reference to FIGS. 1A to 1C. FIGS. 1A to 1C are explanatory diagrams showing one example of stereoscopic content.

In an information processing apparatus 10 according to the embodiments of the present disclosure, for example, content (stereoscopic content) utilizing a display method in which stereoscopic 3D display is not performed from the front of the screen, but browsing is carried out by offsetting the viewpoint position is executed. As examples of such display method, the above-mentioned phantogram, desktop virtual reality, fishtank virtual reality, and the like can been mentioned.

In FIG. 1A to FIG. 1C, the content of content displayed on a display screen D provided in a certain information processing apparatus is schematically shown. It is assumed that a triangular prism object OBJ1, a female character OBJ2, and a male character OBJ3 are displayed in the content shown in FIGS. 1A to 1C. Also, in FIGS. 1A to 1C, the viewpoint direction of the user looking at the display screen D is conveniently shown by an arrow object L.

It is assumed that the mutually-relative positional relationships of the above-mentioned display objects OBJ1, OBJ2, OBJ3 are associated with each other using a fixed coordinate system on the display screen D. In such a case, if the content is looked at from the front of the display screen D like shown in FIG. 1A, the triangular prism object OBJ1 is displayed as a triangle shape and the human-form characters OBJ2, OBJ3 are displayed as the head section of the characters.

Also, as shown in FIG. 1B, if the user looks at the display screen D from the front near direction (the direction shown by object L in FIG. 1B) of the display screen, the triangular prism object OBJ1 is displayed as a side surface of the triangular prism and the human-form characters OBJ2, OBJ3 are displayed as the whole body of the characters.

Furthermore, as shown in FIG. 1C, if the user looks at the display screen D from the front diagonal direction (the direction shown by object L in FIG. 1C) of the display screen, each object OBJ1, OBJ2, OBJ3 is displayed as a different appearance to FIG. 1B.

Thus, by a spectroscopic display method such as phantogram, desktop virtual reality, and fishtank virtual reality, an effect of correcting distortion on the screen by such diagonal viewpoint is presented on the display screen according to the viewpoint position from which the user views the display screen D. For this reason, since the stereoscopic feel is only enhanced by these display methods when content is gazed at from a certain specific position (for example, front forward 30° position or the like), where the viewpoint position of the user exists becomes an important element.

Thus, in the information processing apparatus according to the first embodiment of the present disclosure explained below, the viewpoint position of the user is specified while suppressing processing load and deterioration in operational feel of the user.

Also, in the information processing apparatus according to the second embodiment of the present disclosure explained below, so that it becomes possible for the user to more easily browse stereoscopic content like that mentioned above, the viewpoint of the user is guided so that the viewpoint of the user is included in a range suitable for the content.

### First Embodiment

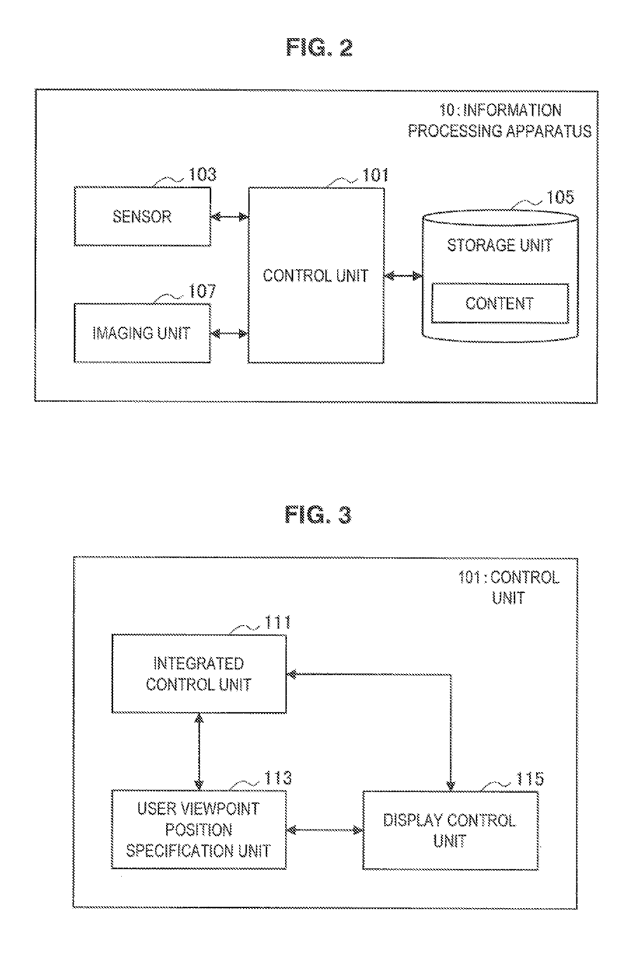

Hereinafter, the information processing apparatus and the information processing method according to the first embodiment of the present disclosure are explained in detail with reference to FIGS. 2 to 14. The information processing apparatus 10 according to the present embodiment is a device that can specify the viewpoint position of the user while suppressing processing addition and deterioration in the operational feel of the user.

### <Regarding the Configuration of the Information Processing Apparatus>

Firstly, regarding the entire configuration of the information processing apparatus 10 according to the present embodiment is explained with reference to FIG. 2. FIG. 2 is a block diagram showing the configuration of the information processing apparatus 10 according to the present embodiment.

As the information processing apparatus 10 according to the present embodiment, for example, portable devices such as a digital camera, a smart phone, a tablet; equipment for which stereoscopic imaging is possible; and the like can be mentioned. Hereinafter, an explanation is performed giving the example of when the information processing apparatus 10 according to the present embodiment is a smart phone or a tablet.

The information processing apparatus 10 according to the present embodiment, as shown in FIG. 2, mainly includes a control unit 101, a sensor 103, and a storage unit 105. Also, the information processing apparatus 10 according to the present embodiment may further include an imaging unit 107.

The control unit 101 is realized by, for example, a central processing unit (CPU), a read only memory (ROM), a random access memory (RAM), and the like. The control unit 101 is a processing unit that performs execution control of various processes executable by the information processing apparatus 10 according to the present embodiment. The configuration of this control unit 101 is further explained in detail below.

The sensor 103 measures the acceleration operating on the information processing apparatus 10 according to the present embodiment. As one example of such sensor, for example, a three-axis acceleration sensor including an acceleration sensor and a gravity detection sensor can be mentioned. The sensor 103, under control by the control unit 101, measures the acceleration at a given rate and outputs data showing the measured result (Hereinafter, also referred to as sensor information) to the control unit 101. Also, the sensor 103 may store the obtained sensor information in the after-mentioned storage unit 105 or the like.

The storage unit 105 is realized by the RAM, a storage device, or the like included in the information processing apparatus 10 according to the present embodiment. Various data used in various processes executed by the control unit 101, various databases, look-up tables, and the like are stored in the storage unit 105. Also, measurement data measured by the sensor 103 according to the present embodiment, entity data of a picked up image imaged by the after-mentioned imaging unit 107, various programs, parameters, and data used in the processes executed by the control unit 101 of the present embodiment, and the like may be recorded in the storage unit 105. Also, in addition to these data, it is possible to arbitrarily store in the storage unit 105 various content executable by the information processing apparatus 10 according to the present embodiment, various parameters and midway progress of processes for which storing has become necessary when the information processing apparatus 10 performs some process, and the like. This storage unit 105 can be freely accessed by each processing unit such as the control unit 101, the sensor 103, and the imaging unit 107, and can freely write and read data.

The imaging unit 107 is realized by a camera externally connected to the information processing apparatus 10, a camera embedded in the information processing apparatus 10, or the like. The imaging unit 107, under control by the control unit 101, images a picked up image including the face of the user of the information processing apparatus 10 at a given frame rate, and outputs data of the obtained picked up image to the control unit 101. Also, the imaging unit 107 may store data of the obtained picked up image in the storage unit 105 or the like.

Also, the information processing apparatus 10 according to the present embodiment, in addition to the processing units shown in FIG. 2, in accordance with various functions the information processing apparatus 10 provides to the user, may also have various well-known processing units for performing such functions.

Above, regarding the entire configuration of the information processing apparatus 10 according to the present embodiment was explained with reference to FIG. 2.

### [Regarding the Configuration of the Control Unit 101]

Next, regarding the configuration of the control unit 101 included in the information processing apparatus 10 according to the present embodiment is explained with reference to FIG. 3. FIG. 3 is a block diagram showing the configuration of the control unit 101 included in the information processing apparatus 10 according to the present embodiment.

The control unit 101 according to the present embodiment, as shown in FIG. 3, mainly includes an integrated control unit 111, a user viewpoint position specification unit 113, and a display control unit 115.

The integrated control unit 111 is realized by, for example, the CPU, the ROM, the RAM, and the like. The integrated control unit 111 is a processing unit that controls by integrating the various processes executed by the information processing apparatus 10 according to the present embodiment. Under control of the integrated control unit 111, it becomes possible for each processing unit that the information processing apparatus 10 according to the present embodiment has to realize various processes while cooperating with each other according to necessity.

The user viewpoint position specification unit 113 is realized by, for example, the CPU, the ROM, the RAM, and the like. The user viewpoint position specification unit 113 according to the present embodiment uses sensor information generated by the sensor 103 included in the information processing apparatus 10 so as to specify the viewpoint position of the user based on the posture of the information processing apparatus 10 (posture realized by being held by the user). The user viewpoint position specification unit 113 may estimate the viewpoint position of the user each time sensor information is output from the sensor 103, or may estimate the viewpoint position of the user at a given period different to the output rate of sensor information.

The information representing the viewpoint position of the user specified by the user viewpoint position specification unit 113 (Hereinafter, also referred to as viewpoint position information.) is output to the integrated control unit 111 and an after-mentioned display control unit 113, and is used in various processes executed by these processing units.

Regarding the specific configuration of the user viewpoint position specification unit 113 according to the present embodiment is explained in detail below.

The display control unit 115 is realized by, for example, the CPU, the ROM, the RAM, an output device, and the like. The display control unit 115 performs display control of a display screen in a display device such as a display included in the information processing apparatus 10, a display device such as a display that is provided external to the information processing apparatus 10 and that can communicate with the information processing apparatus 10, or the like. Specifically, the display control unit 115 according to the present embodiment executes content stored in the storage unit 105 or the like so as to display the content of the content on the display screen. Also, when the display control unit 115 executes stereoscopic content like shown in FIGS. 1A to 1C, for example, a well-known image perspective conversion technique achieving a similar effect to tilt-shift imaging of a camera lens can be applied.

By the display control unit 115 performing control of the display screen, it becomes so that various information browsable by the user is displayed on the display screen of the information processing apparatus 10 for example.

### <Regarding the Configuration of the User Viewpoint Position Specification Unit>

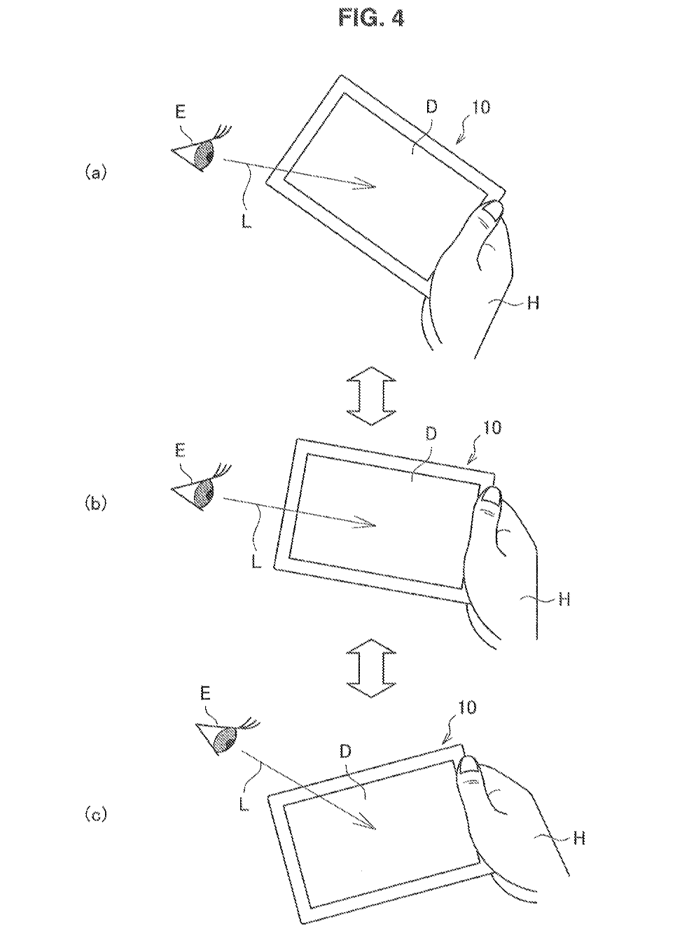

Next, regarding the configuration of the user viewpoint position specification unit 113 according to the present embodiment is explained with reference to FIGS. 4 to 13.

FIG. 4 is an explanatory diagram showing one example of the relationship between the holding state of the information processing apparatus and the viewpoint position. As shown in FIGS. 4(a) to 4(c), by the user holding the information processing apparatus 10 using his/her hand H, it becomes so that the relative positional relationship between a viewpoint E and the display screen D, and a distance L between the viewpoint E and the display screen D changes.

In the user viewpoint position specification unit 113 according to the present embodiment, in advance, what postures the information processing apparatus 10 becomes in normal holding states of the casing of the information processing apparatus 10 is sampled, and a collection of such postures is used as reference posture information. In this reference position information, the normal relative positional relationship between the viewpoint E and the display screen D, and the reference value of the distance L between the viewpoint E and display screen D are associated as reference information. The user viewpoint position specification unit 113 specifies the posture of the information processing apparatus 10 based on sensor information, extracts one or a plurality of reference posture states near the specified position, and specifies the viewpoint position of the user based on the extracted reference posture state(s).

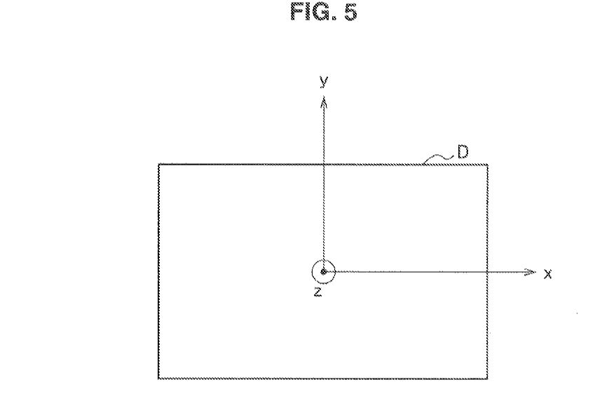

FIG. 5 is an explanatory diagram showing one example of the coordinate system used in explanation of the present embodiment. As shown in FIG. 5, in the explanation below, a coordinate system in which the display screen D is the xy-plane and the normal direction of the display screen D is the z-axis positive direction is conveniently used. In the information processing apparatus 10 according to the present embodiment, objects (objects like shown in FIGS. 1A to 1C) included in content are displayed based on a coordinate system inherent to the device like shown in FIG. 5 for example.

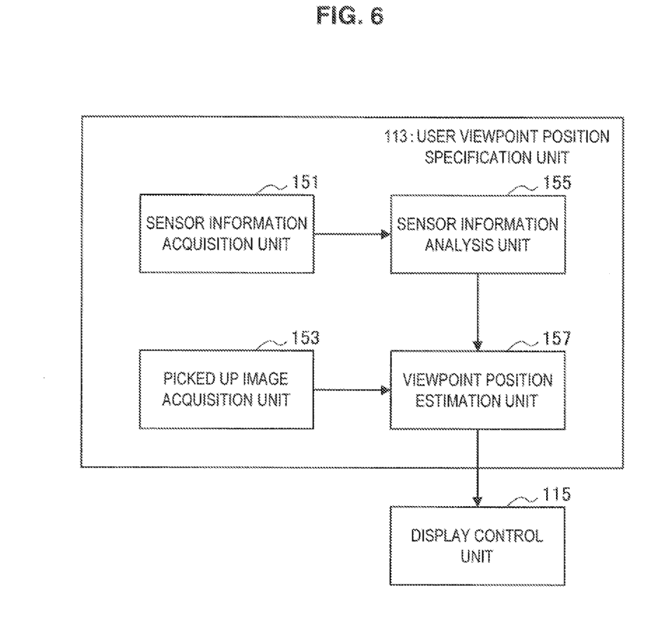

FIG. 6 is a block diagram showing the configuration of the user viewpoint position specification unit 113 according to the present embodiment. The user viewpoint position specification unit 113 according to the present embodiment, as exemplified in FIG. 6, mainly includes a sensor information acquisition unit 151, a picked up image acquisition unit 15, a sensor information analysis unit 155, and a viewpoint position estimation unit 157.

The sensor information acquisition unit 151 is realized by, for example, the CPU, the ROM, the RAM, a communications device, and the like. The sensor information acquisition unit 151, for example, acquires sensor information generated by the sensor 103 included in the information processing apparatus 10 and transmits this to the after-mentioned sensor information analysis unit 155. Also, the sensor information acquisition unit 151 may associate time information representing the day and time or the like when the sensor information was acquired with the acquired sensor information, and store this as historical information in the storage unit 105.

The picked up image acquisition unit 153 is realized by, for example, the CPU, the ROM, the RAM, the communications device, and the like. The picked up image acquisition unit 153, for example, if a picked up image including the vicinity of the user's face generated by the imaging unit 107 included in the information processing apparatus 10 exists, acquires this picked up image and transmits such to the after-mentioned viewpoint position estimation unit 157. Also, the picked up image acquisition unit 153 may associate, with the data of the acquired picked up image, time information representing the day and time or the like when such data was acquired, and store this as historical information in the storage unit 105 or the like.

The sensor information analysis unit 155 is realized by, for example, the CPU, the ROM, the RAM, and the like. The sensor information analysis unit 155, based on sensor information transmitted from the sensor information acquisition unit 151, analyzes the direction of gravity operating on the information processing apparatus 10 (gravity direction) and specifies the posture of the information processing apparatus 10 (the posture of the casing of the information processing apparatus 10).

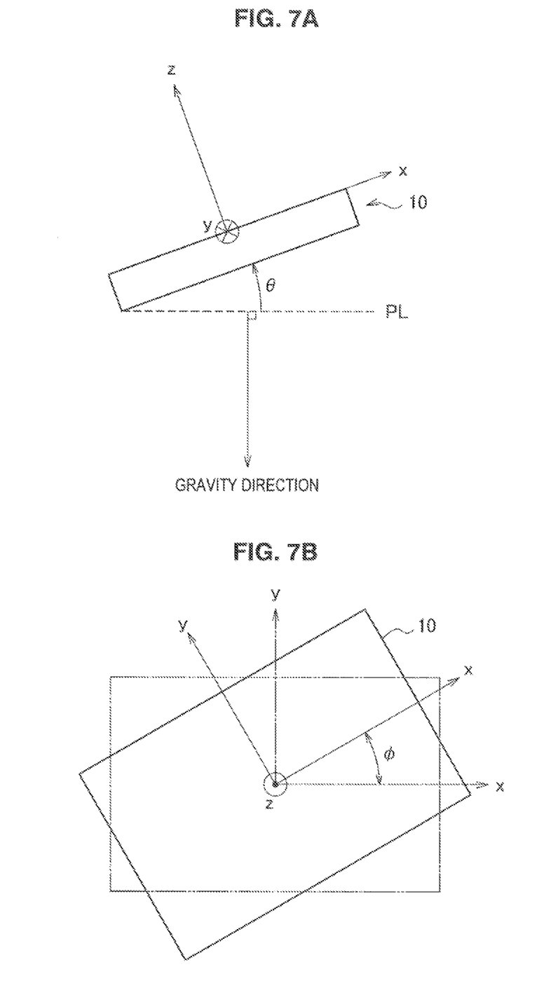

Herein, the sensor information analysis unit 155, when analyzing the gravity direction, focuses on two types of angles as shown in FIGS. 7A and 7B. FIGS. 7A and 7B are explanatory diagrams showing an angle representing the holding state of the information processing apparatus 10. As shown in FIG. 7A, in the present embodiment, a horizontal direction PL is used as a reference and the rotational amount of the information processing apparatus 10 when rotationally moved around the y-axis shown in FIG. 5 is represented by a pitch angle θ. Also, as shown in FIG. 7B, in the present embodiment, the rotational amount of the information processing apparatus 10 when rotationally moved around the z-axis shown in FIG. 5 is represented by a yaw angle φ. To put it another way, the pitch angle θ represents the rotation angle when the information processing apparatus 10 is rotated in the up-down direction and the yaw angle φ represents the rotation angle when the information processing apparatus 10 is rotated in the left-right direction.

The sensor information analysis unit 155, focusing on the gravity component in the y-axis direction and the gravity component in the z-axis direction among the acquired sensor information, calculates the angle θ of the vector (in other words, gravity direction) in the yz-plane defined from this y-axis direction component and z-axis direction component. This angle θ corresponds to the pitch angle θ shown in FIG. 7A. Similarly, the sensor information analysis unit 155, focusing on the gravity component in x-axis direction and the gravity component in the z-axis direction among the acquired sensor information, calculates the angle φ of the vector (in other words, gravity component) in the xz-plane defined from this x-axis direction component and z-axis direction component. This angle φ corresponds to the yaw angle φ shown in FIG. 7B.

When the sensor information analysis unit 155 performs analysis of the gravity direction, and calculates the angle θ and the angle φ as mentioned above, information regarding these calculated angles (Hereinafter, also referred to as angle information.) is output to the after-mentioned viewpoint position estimation unit 157.

In addition, the sensor information analysis unit 155 may associate time information representing the day and time or the like when said angle information was acquired with the calculated angle information, and store this as historical information in the storage unit 105 or the like.

The viewpoint position estimation unit 157 is realized by, for example, the CPU, the ROM, the RAM, and the like. The viewpoint position estimation unit 157 estimates the viewpoint position of the user based on a profile regarding the viewpoint position of the user set in advance and the posture of the casing analyzed by the sensor information analysis unit 155.

In the information processing apparatus 10 according to the present embodiment, as aforementioned, the normal holding states of the information processing apparatus 10 are classified in advance into several types, and, in each of these holding states, the posture of the casing when the casing of the information processing apparatus 10 is moved in various angles (pitch angles) and the viewpoint position of the user with respect to the casing at such time are associated with each other. Such prior information is stored in the storage unit 105 or the like in advance, and is used in the viewpoint position estimation unit 157 as reference posture information, in other words, profiles.

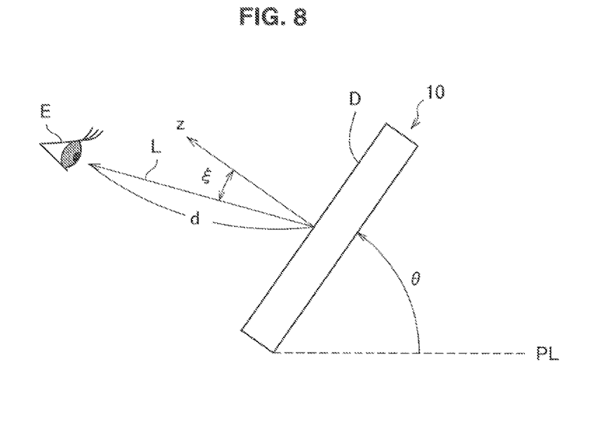

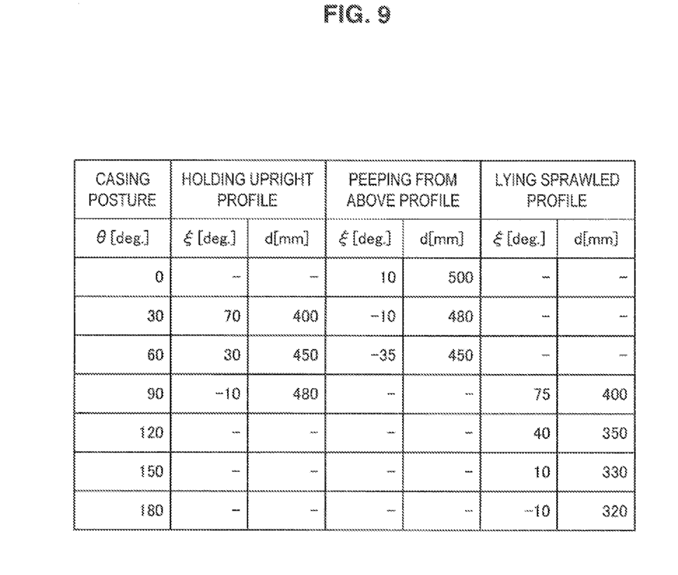

FIG. 8 is an explanatory diagram for explaining about the viewpoint position of the user, and FIG. 9 is an explanatory diagram showing one example of a profile used in the viewpoint position estimation unit 157 according to the present embodiment. As shown in FIG. 9, in the information processing apparatus 10 according to the present embodiment, it is classified into multiple states such as holding upright state, peeping from above state, lying sprawled state, and the like as holding states of the information processing apparatus 10 by the user. The holding states shown in FIG. 9 are merely one example, and is not limited to the holding states showing in FIG. 9. Furthermore, various states that can be considered such as lying down on one's side state and the like can be set.

Also, as shown in FIG. 9, in the profile of each holding state, the viewpoint direction of the user (angle ξ in FIG. 8: unit deg.) and a separation distance d (unit: mm) between the viewpoint and the display screen are associated with each other according to the posture of the casing (in other words, the calculated pitch angle θ). Regarding each holding state, the posture of the casing is multiply set at a given angle interval (in FIG. 9, a 30° angle interval) in the range of 0° to 180°. The angle interval is not limited to the example shown in FIG. 8, and may be set at, for example, a 10° increment, or set at a further finer angle, according to required estimation accuracy, usable resources in the apparatus, and the like.

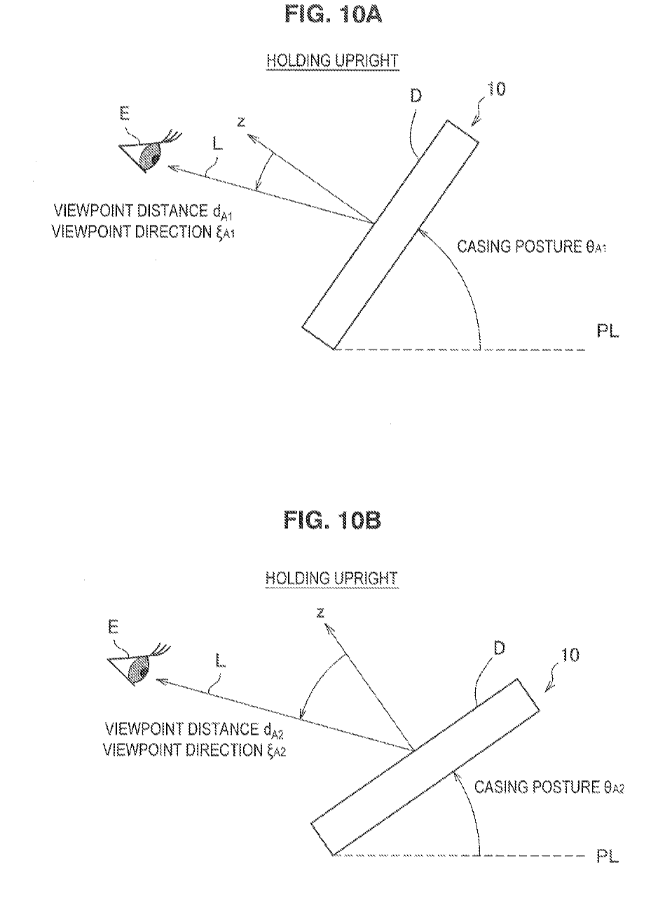

FIGS. 10A to 10C show one example of the profiles in the holding upright state (in other words, the state of the user holding the information processing apparatus 10 in an upright state). In these profiles, the angle ξ is defined as the angle formed between the viewpoint direction and the z-axis. As shown in FIGS. 10A and 10B, if the posture θ of the casing is inclined with respect to the horizontal direction PL (the case of θ=θ_{A1}, θ_{A2}), the viewpoint direction L and the viewpoint position E can be set. However, as shown in FIG. 10C, in the holding upright state, if the information processing apparatus 10 is placed horizontally (the case of) θ_{A3}=0°, the viewpoint direction L and the viewpoint position E cannot be determined.

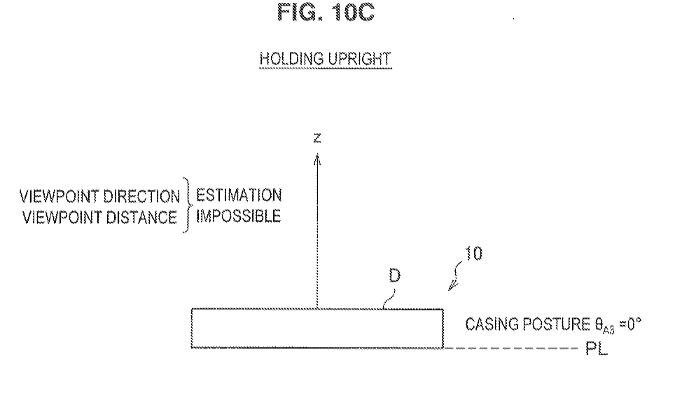

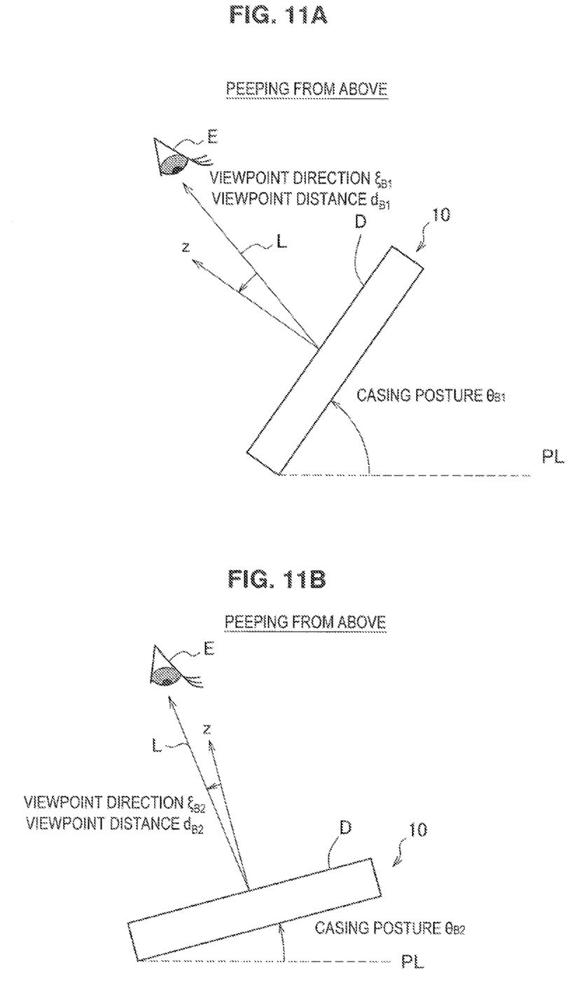

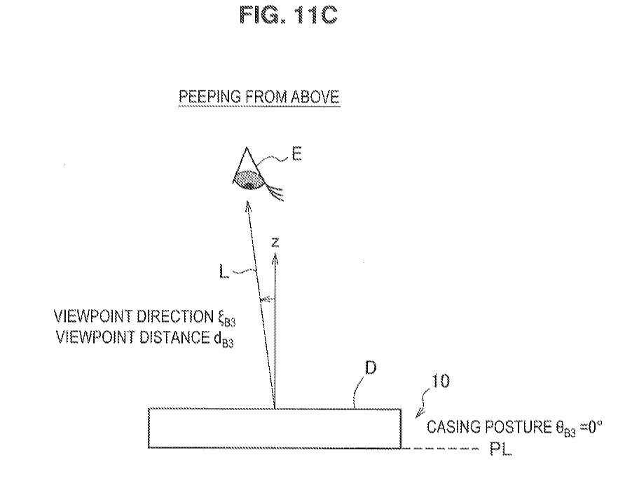

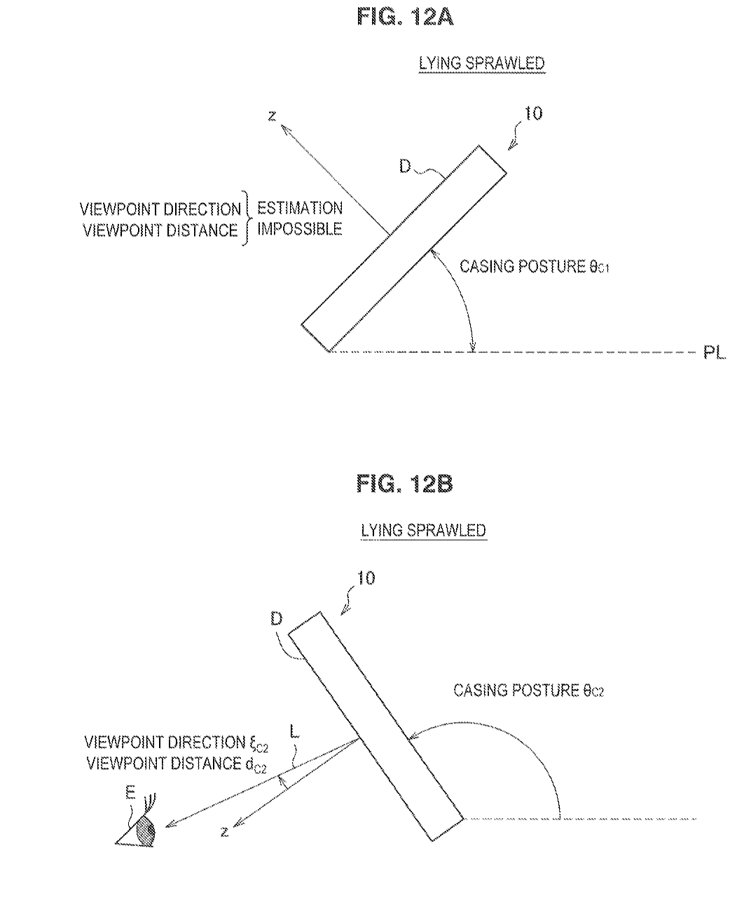

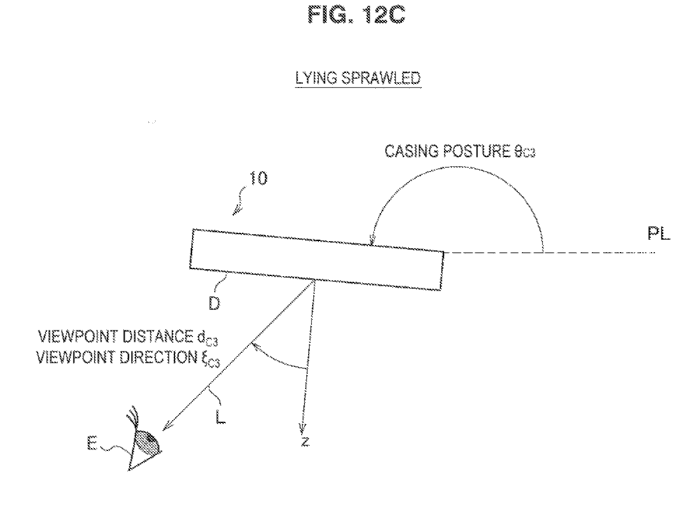

FIGS. 11A to 11C show one example of profiles corresponding to the case of the user peeping from above at the information processing apparatus 10. Also, FIGS. 12A to 12C show one example of profiles corresponding to the case of the user holding the information processing apparatus in the state of lying sprawled out on one's back. In these profiles also, the angle ξ is defined as the angle formed between the viewpoint direction and the z-axis.

As is clear from FIGS. 9 to 12C, it can be understood that, for each of these holding states, there exists a range in which the viewpoint direction L and the viewpoint position E of the user cannot be specified based on the posture angle θ of the casing. By the viewpoint position estimation unit 157 according to the present embodiment, the viewpoint position of the user can be estimated using only the output from the acceleration sensor based on the knowledge (profile) obtained by such prior sampling process.

Hereinafter, the estimation process of the viewpoint position executed by the viewpoint position estimation unit 157 is specifically explained with reference to FIGS. 8 and 9.

The viewpoint position estimation unit 157 firstly specifies the angle θ representing a posture of the casing like shown in FIG. 8 by referring to angle information output from the sensor information analysis unit 155. Next, the viewpoint position estimation unit 157, by referring to the profiles shown in FIG. 9, acquires the profile closest to the obtained angle θ, or acquires one or a plurality of values in the vicinity of the angle θ, and specifies the corresponding viewpoint direction and distance. Also, when values in the vicinity are acquired, a complementary process using a number of the close data may be performed, so as to complement the obtained viewpoint direction and distance. By such process, the viewpoint position estimation unit 157 can, for example, specify the visual line direction ξ of the user shown in FIG. 8.

Next, the viewpoint position estimation unit 157 specifies the size of the yaw angle φ by referring to angle information output from the sensor information analysis unit 155. Subsequently, the viewpoint position estimation unit 157 rotates the specified visual line direction ξ of the user only φ by using the obtained angle φ. Thereby, the viewpoint position estimation unit 157 can estimate the final visual line direction and viewpoint position of the user.

In addition, the viewpoint position estimation unit 157 may block the continuous process if the obtained angle θ is in an inappropriate range in the profile. Thereby, it becomes possible to prevent a wrong reaction and wrong operation. In addition, if the continuous process is blocked, the information processing apparatus 10 can perform handling such as stopping update of the displayed viewpoint position, returning to the front near viewpoint, and the like.

The viewpoint position estimation unit 157 outputs the thus obtained information regarding the viewpoint position of the user (viewpoint position information) to, for example, the display control unit 115. It becomes possible for the display control unit 115 to, for example, perform display control of stereoscopic content by referring to the communicated viewpoint position information.

In the above-mentioned explanation, it is explained regarding when the viewpoint position estimation unit 157 estimates the viewpoint position of the user by referring to only the sensor information. Herein, if the viewpoint position estimation unit 157 can use a picked up image imaged by the imaging unit 107, it becomes possible to more accurately estimate the viewpoint position of the user by using a method like explained below.

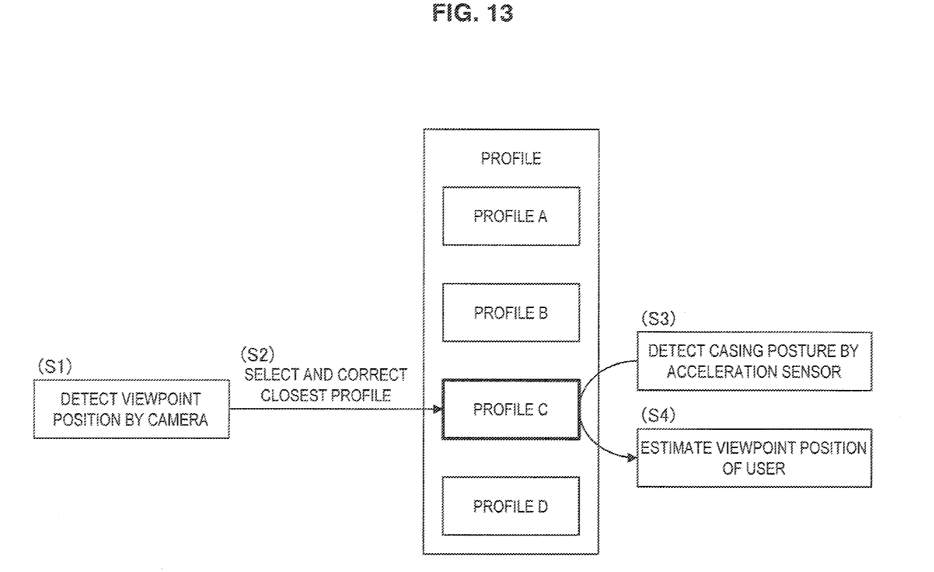

Hereinafter, the estimation method of the viewpoint position of the user using both sensor information and a picked up image is explained in detail with reference to FIGS. 8, 9, and 13. FIG. 13 is an explanatory diagram for explaining the estimation process of the viewpoint position when used together with a picked up image.

It is predicted that the holding posture of the information processing apparatus 10 by the user can significantly constantly change particularly in the case of realizing the information processing apparatus 10 as a mobile terminal. With respect to this, by a single holding state profile, there is a feeling of discomfort in the way of display by change in the posture of the user.

In order to overcome such discomfort accompanied by change in the holding posture, detecting the position of the eyes of the user by a camera connected to or embedded in the information processing apparatus, and roughly calculating the absolute positional relationship between the display screen and the user based on the position of the eyes and the distance between both eyes can be considered. However, as aforementioned, the angle of view of the camera is often smaller than the peeping angle of the viewpoint, the calculation process of distance and the like is complex, and the camera frame rate is inferior compared to the sensing rate of the acceleration sensor.

Thus, by the viewpoint position estimation unit 157 according to the present embodiment, in addition to posture change detection at a high rate (for example, 60 Hz or more) by the acceleration sensor, a correction process of the viewpoint position using the picked up image by the camera at a regular low rate (for example, a few Hz or less) may be performed.

When doing so, if a low frame rate of the camera is applied as is to the user operation, it is considered that various discomforts, such as delay, rattling, and the like from the lowness of the update rate, occur. Thus, the viewpoint position information estimation unit 157 according to the present embodiment, as shown in FIG. 13, firstly calculates the viewpoint position of the user by a well-known method using the picked up image imaged by the camera (S1). Thereafter, the viewpoint position estimation unit 157 does not use the absolute viewpoint position calculated based on the imaging image in the process as the viewpoint position of the user, but uses for selection of a profile like mentioned above (S2). The viewpoint position estimation unit 157 detects the posture of the casing based on sensor information by the acceleration sensor (S3) and estimates the viewpoint position of the user based on the selected profile using the picked up image (S4).

Thereby, feedback for an operation of the user (for example, change of the holding posture of the casing) becomes based on a value estimated by the acceleration sensor and is not influenced by the angle range that can be detected and decline in the frame rate. As a result, feedback to the user by a high frame rate can be realized.

Hereinafter, regarding the estimation method of the viewpoint position of the user using sensor information and a picked up image is specifically explained with reference to FIGS. 8 and 9.

Now, by the viewpoint position estimation unit 157, as shown in FIG. 8, the posture θ of the casing is obtained based on the sensor information, and also, the viewpoint direction ξ of the user and the distance d to the viewpoint are calculated by a well-known method based on the picked up image. In this case, the posture of the casing that the profile has is written as θₚ, the viewpoint direction that the profile has is written as ξₚ, and the viewpoint distance that the profile has is written as dₚ. The viewpoint position estimation unit 157, regarding θₚ in which |θ−θₚ| becomes a minimum for each profile, calculates a difference DO by the below-mentioned formula 101 for example. In the below-mentioned formula 101, k is a certain constant.

[Equation 1]

D_{θ}=\sqrt{k·(d−dₚ)²+(ξ−ξₚ)²} (Formula 101)

Herein, the profile having the smallest value of D_{θ} determined for each profile becomes a candidate of the profile that should be selected. When this candidate becomes the same profile in succession a certain constant number of times or more, the viewpoint position estimation unit 157 selects such profile as the applicable profile in the state being focused on.

For example, it is assumed that the posture of the casing is detected as 60° in the case that a profile like shown in FIG. 9 was set in advance. In the case that the viewpoint direction was 20° and the viewpoint distance was 400 mm when calculated based on the picked up image, the viewpoint position estimation unit 157 checks against the above-mentioned formula 101 and selects the holding upright state in which D₆₀ becomes a minimum as the profile that should be used.

As aforementioned, if the viewpoint position of the user is secondarily used based on the picked up image, the viewpoint position estimation unit 157 may use information regarding the viewpoint position of the user calculated based on the picked up image in updating a profile like shown in FIG. 9. For example, there are many cases in which the viewpoint distance d becomes of value inherent to the user according to physical characteristics or the like of the user. For this reason, in the case in which the viewpoint position is stably detected by a camera and the profile is stably selected, the viewpoint distance d which the profile has may be updated as needed by the viewpoint distance obtained by the camera. Thereby, generation of a profile adapted to the individual user becomes possible, and it becomes possible to perform estimation of a viewpoint position having further higher accuracy by using a profile dedicated to each user. In addition, when the viewpoint direction based on the picked up image was not detectable, it is preferable to not perform profile updating.

Thus, by secondarily using the knowledge obtained from the picked up image in addition to the sensor, even in cases where a large change in the posture of the casing is predicted by the rotation amount of the casing exceeding a given range and the calculated viewpoint position exceeding a given threshold value, it becomes possible to select the closest profile by calculating the absolute viewpoint position of the user using the picked up image obtained by the camera and also combining the current posture state of the information processing apparatus.

Above, one example of the function of the information processing apparatus 10 according to the present embodiment was shown. Each of the structural elements described above may be configured using a general-purpose material or circuit, or may be configured from hardware dedicated to the function of each structural element. Also, the function of each structural element may all be performed by the CPU and the like. Accordingly, the hardware configuration to be used can be changed as appropriate according to the technical level at the time of carrying out the present embodiment.

In addition, it is possible to create a computer program for realizing each function of the information processing apparatus according to the present embodiment like that mentioned above and implement the computer program on a personal computer or the like. Also, a computer-readable storage medium on which such computer program is stored can also be provided. The storage medium is, for example, a magnetic disk, an optical disk, a magneto-optical disk, a flash memory, or the like. Also, the above-mentioned computer program may be distributed via a network for example without using a storage medium.

### <Regarding the Flow of the Information Processing Method>

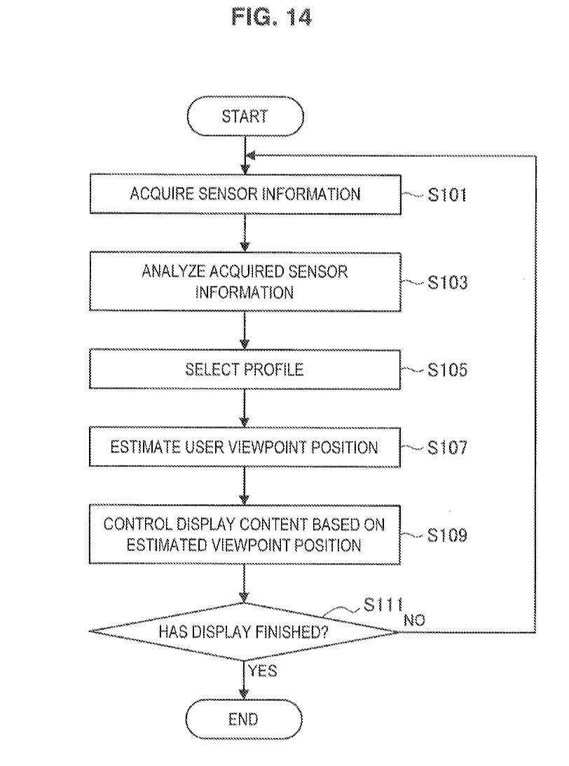

Next, regarding one example of the flow of the information processing method (in other words, the estimation method of the viewpoint position of the user) according to the present embodiment is simply explained with reference to FIG. 14. FIG. 14 is a flowchart showing one example of the information processing method according to the present embodiment.

In the information processing method according to the present embodiment, firstly, the sensor information acquisition unit 151 of the user viewpoint position specification unit 113 acquires sensor information output from the sensor 103 (step S101), and transmits this to the sensor information analysis unit 155.

Thereafter, the sensor information analysis unit 155 analyzes the acquired sensor information (step S103), specifies the posture of the casing, and outputs the obtained result to the viewpoint position estimation unit 157 as angle information.

The viewpoint position estimation unit 157 selects a profile used for estimating the viewpoint position of the user from among the plurality of profiles set in advance by using the angle information output from the sensor information analysis unit 157 (step S105). Thereafter, the viewpoint position estimation unit 157 estimates the viewpoint position of the user using the selected profile and the angle information output from sensor information analysis unit 157 (step S107). The viewpoint position estimation unit 157, when the viewpoint position of the user is estimated, outputs the obtained estimation result to the display control unit 115.

The display control unit 115 controls the display content displayed on the display screen based on the viewpoint position information regarding the viewpoint position of the user output from the viewpoint position estimation unit 157 (step S109). Thereby, display control according to the viewpoint position of the user is realized.

Thereafter, the display control unit 115 determines whether the operation of ending display of content and the like has been performed (step S111). If the operation for ending the process has not been performed by the user, the user viewpoint position specification unit 113 returns to step S101 and continues the process. Also, if the operation for ending the process has been performed by the user, the user viewpoint position specification unit 113 ends the estimation process of the viewpoint position of the user.

Above, one example of the flow of the information processing method according to the present embodiment was simply explained with reference to FIG. 14.

As explained above, in the information processing apparatus 10 according to the first embodiment of the present disclosure, only posture information of the information processing apparatus is used when estimating the viewpoint position of the user. For this reason, although a strict viewpoint position that can handle when only the head section of the user is moved is not possible, it becomes possible to provide fast feedback with lighter processing than performing strict viewpoint position detection. As a result, there are the characteristics that, for the user, the feeling of operating the information processing apparatus 10 is good and it is difficult to feel discomfort in not performing strict viewpoint position detection. Also, since the movable scope of the sensor is very wide, operation of the information processing apparatus 10 in a free range becomes possible.

### Second Embodiment

As aforementioned, although content in which the stereoscopic feel is enhanced when browsed from a certain specific position exists in stereoscopic content, when browsing is performed from positions other than the specific viewpoint position, various browsing loads, such as crosstalk occurs, objects appear distorted, and images of the display objects are unable to be formed, arise on the user. Thus, in the information processing apparatus according to the second embodiment of the present disclosure hereinafter explained, so it becomes possible for a user to more easily browse stereoscopic content as mentioned above, the viewpoint of the user is guided so as to be included in a range in which the viewpoint of the user is suitable for the content.

The entire configuration of the information processing apparatus 10 according to the present embodiment is the same as the information processing apparatus 10 according to the first embodiment shown in FIG. 2, and the configuration of the control unit 101 provided in the information processing apparatus 10 of the present embodiment is also the same as the information processing apparatus 10 according to the first embodiment shown in FIG. 3. Accordingly, a detailed explanation is omitted below.

In addition, the user viewpoint position specification unit 113 provided in the information processing apparatus 10 according to the present embodiment may execute a specific process on the viewpoint position of the user utilizing sensor information like explained in the first embodiment, or may perform a well-known process of calculating the viewpoint position of the user from the space, size, or the like of both eyes using a picked up image in which is imaged a portion including the face of the user.

### <Regarding the Configuration of the Display Control Unit>

Hereinafter, regarding the configuration of the display control unit 115 provided in the information processing apparatus 10 according to the present embodiment is explained in detail.

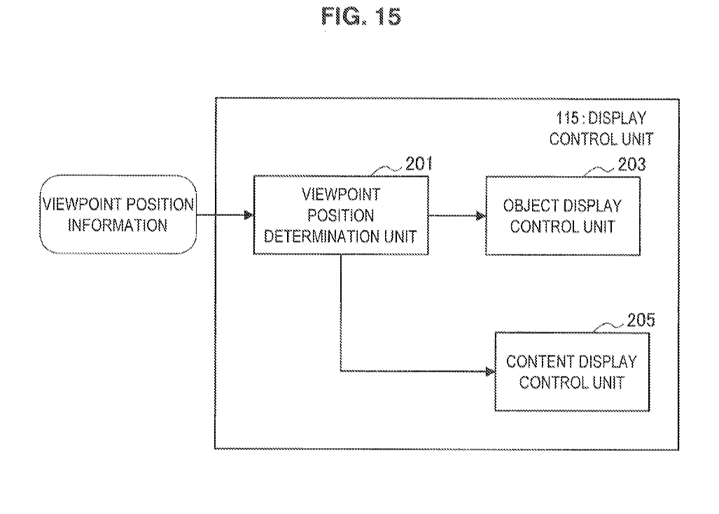

FIG. 15 is a block diagram showing the configuration of the display control unit 115 included in the information processing apparatus 10 according to the present embodiment.

The display control unit 115 according to the present embodiment, as shown in FIG. 15, mainly includes a viewpoint position determination unit 201, an objection display control unit 203, and a content display control unit 205.

The viewpoint position determination unit 201 is realized by, for example, the CPU, the ROM, the RAM, and the like. The viewpoint position determination unit 201 determines whether the viewpoint position of the user is included in the viewpoint position range suitable for the content based on viewpoint position information, which represents the viewpoint position of the user, output from the user viewpoint position specification unit 113.

Herein, in content (for example, stereoscopic content) executed by the information processing apparatus 10 according to the present embodiment, information relating to the preferable viewpoint position range for viewing such content is associated as metadata. Although there are no particular limitations on how the preferable viewpoint position range is specified, for example, the viewpoint position range can be specified by a polar coordinate display defined with reference to the display screen. Although there are no particular limitations also regarding the designation method of the viewpoint position range using the polar coordinate display, for example, the preferable viewpoint position range can be specified using the pitch angle θ and the yaw angle φ like shown in FIGS. 7A and 7B, and the distance d to the viewpoint like shown FIG. 8, or the like.

The viewpoint position determination unit 201 executes content that an integrated control unit 111 has, and if display control of this content is requested by the integrated control unit 111, information regarding the preferable viewpoint position range of the content is acquired by referring to the metadata associated with the content. Thereafter, the viewpoint position determination unit 201 determines whether the viewpoint position corresponding to the viewpoint position information is included in the preferable viewpoint position range by referring to a parameter representing the viewpoint position included in the viewpoint position information output from the user viewpoint position specification unit 113.

The viewpoint position determination unit 201, if the viewpoint position corresponding to the viewpoint position information is not included in the preferable viewpoint position range, makes a request to the after-mentioned object display control unit 203 for display control of a viewpoint guidance object. Also, the viewpoint position determination unit 201 preferably transmits to the object display control unit 203 at least one of either the viewpoint position information output from the user viewpoint position specification unit 113 or information relating to the deviation amount of the viewpoint position of the user from the preferable viewpoint position range (the deviation amount includes the size of deviation and the direction of deviation).

On the other hand, the viewpoint position determination unit 201, if the viewpoint position corresponding to the viewpoint position information is included in the preferable viewpoint position range, makes a request to the after-mentioned content display control unit 205 for display control of content.

Also, the viewpoint position determination unit 201 executes the above-mentioned determination process based on the viewpoint position information transmitted to the viewpoint position determination unit 201. For this reason, if a viewpoint position of the user that was not included in the preferable viewpoint position range becomes so as to be included in the preferable viewpoint position range with transition in time, the content displayed on the display screen is switched from the viewpoint guidance object to the content.

The object display control unit 203 is realized by, for example, the CPU, the ROM, the RAM, and the like. The object display control unit 203, if the viewpoint position of the user is not included in a viewpoint position range suitable for the content (preferable viewpoint position range), performs display control for displaying a viewpoint guidance object that guides the viewpoint of the user to the preferable viewpoint position range.

There are no particular limitations regarding the shape of the viewpoint guidance object displayed on the display screen by the object display control unit 203, and it is possible to use any shape as long it does not impose a load on the user and promotes viewpoint movement by the user. Such viewpoint guidance object, for example, may be an arrow object suggesting the correct direction of the viewpoint, any object that is firstly displayed correctly when it becomes the correct viewpoint position, or the like.

Also, the object display control unit 203 controls the display format of the viewpoint guidance object by referring to at least one of either the viewpoint position information transmitted from the viewpoint position determination unit 201 or information relating to the deviation amount of the viewpoint position of the user from the preferable viewpoint position range.

In addition, the object display control unit 203 preferably changes display of the viewpoint guidance control object according to the transition in time of the viewpoint position of the user corresponding to the viewpoint position information. Also, the object display control unit 203 may display text for guiding the user together with the viewpoint guidance object.

The content display control unit 205 is realized by, for example, the CPU, the ROM, the RAM, and the like. The content display control unit 205 performs display control when displaying on the display screen content corresponding to the content executed by the integrated processing unit 111. By the content display control unit 205 performing display control of the content, it is possible for the user to browse various content such as stereoscopic content.

Above, one example of the function of the information processing apparatus 10 according to the present embodiment was shown. Each of the structural elements described above may be configured using a general-purpose material or circuit, or may be configured from hardware dedicated to the function of each structural element. Also, the function of each structural element may all be performed by the CPU and the like. Accordingly, the hardware configuration to be used can be changed as appropriate according to the technical level at the time of carrying out the present embodiment.

In addition, it is possible to create a computer program for realizing each function of the information processing apparatus according to the present embodiment like that mentioned above and implement the computer program on a personal computer or the like. Also, a computer-readable storage medium on which such computer program is stored can also be provided. The storage medium is, for example, a magnetic disk, an optical disk, a magneto-optical disk, a flash memory, or the like. Also, the above-mentioned computer program may be distributed via a network for example without using a storage medium.

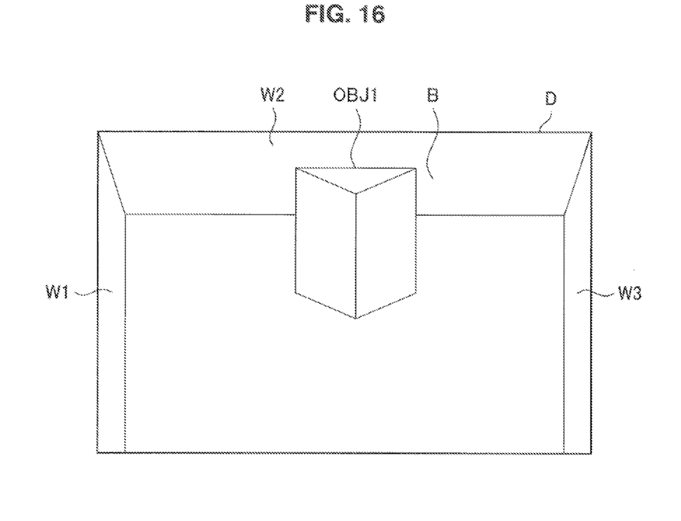

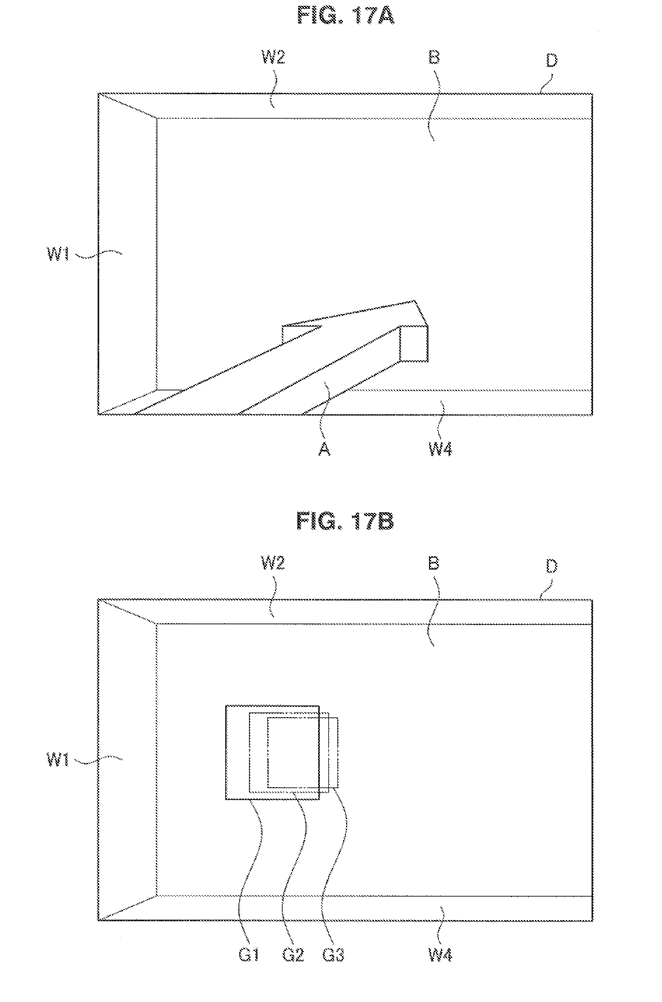

Hereinafter, the display control process by the display control unit 115 according to the present embodiment is specifically explained with reference to FIGS. 16 to 21B. FIG. 16 is an explanatory diagram showing display control in the information processing apparatus according to the present embodiment and FIGS. 17A to 21B are explanatory diagrams showing one example of viewpoint guidance objects according to the present embodiment.

Now, as shown in FIG. 16, a space B partitioned by walls W1, W2, W3 is displayed on the display screen D, and content of a phantogram like displayed by the triangular prism object OBJ1 in this space B is considered.

If the viewpoint position of the user disclosed in the viewpoint position information is included in the preferable viewpoint position range of the content like shown in FIG. 16, a determination result by the viewpoint position determination unit 201 is output to the content display control unit 205. As a result, under display control by the content display control unit 205, content like shown in FIG. 16 is displayed on the display screen D.

On the other hand, if the viewpoint position of the user disclosed in the viewpoint position information is not included in the preferable viewpoint position range, a determination result by the viewpoint position determination unit 201 is output to the object display control unit 203. As a result, the triangular prism object OBJ1 like shown in FIG. 16 is not displayed on the display screen D, and, under control by the object display control unit 203, viewpoint guidance objects like shown in FIGS. 17A to 21B is displayed.

FIGS. 17A and 17B show examples of the viewpoint guidance object displayed if the viewpoint position of the user is wanted to be guided to the left side more than where it is presently. In FIG. 17A, an arrow object A showing the direction of the viewpoint is displayed as a viewpoint guidance object. Also, in FIG. 17B, rectangular objects G1 to G3 are displayed as viewpoint guidance objects. The rectangular objects G1 to G3 are objects displayed so that as the viewpoint position of the user approaches the preferable range, the plurality of rectangles can be seen as integrating together.

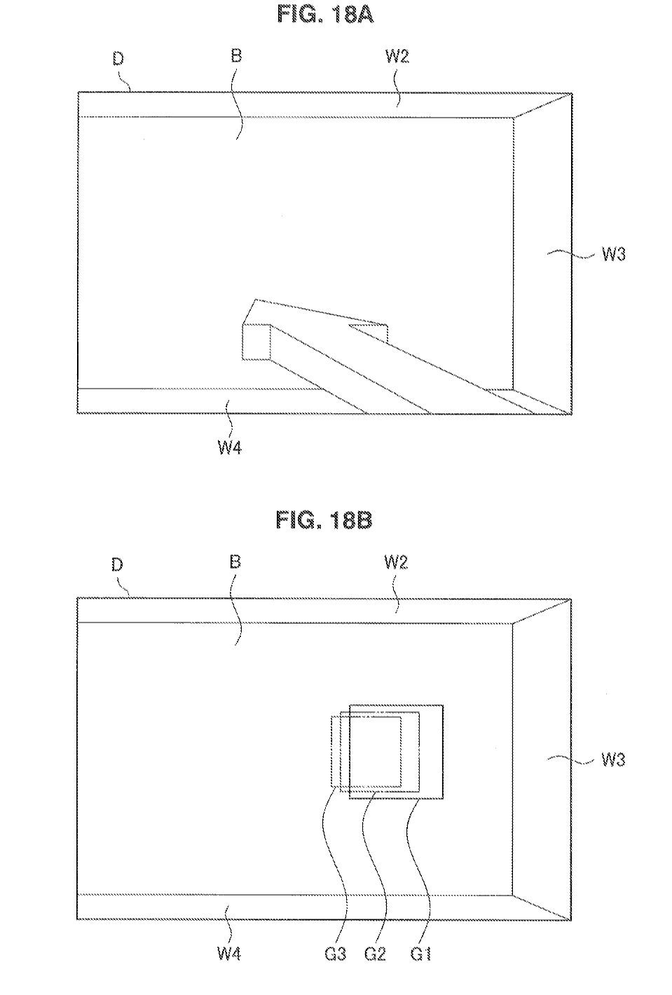

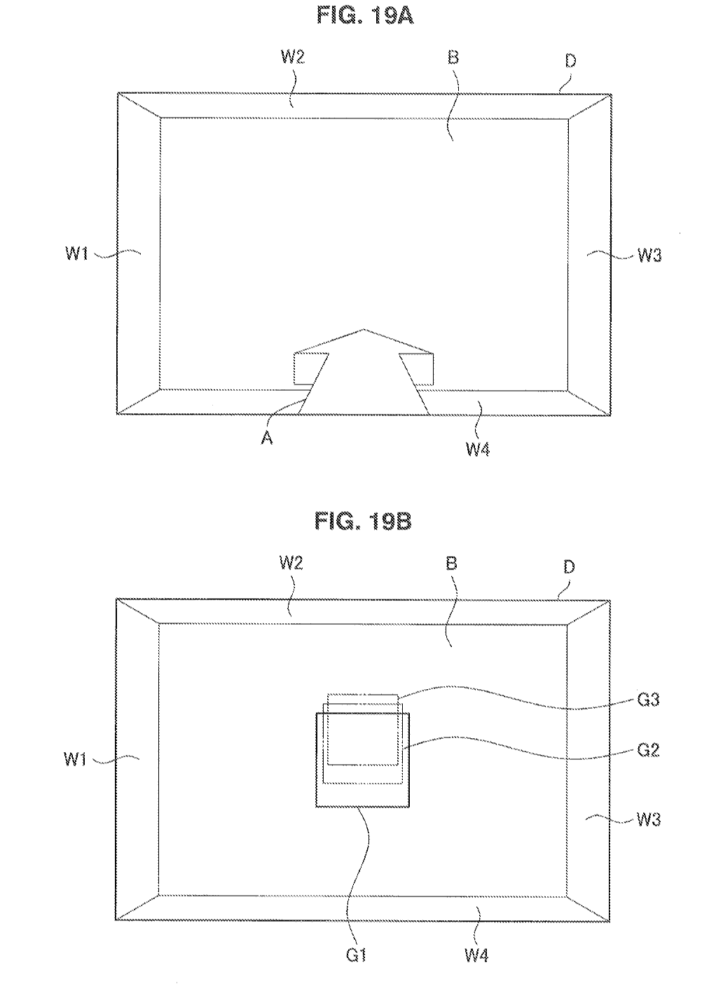

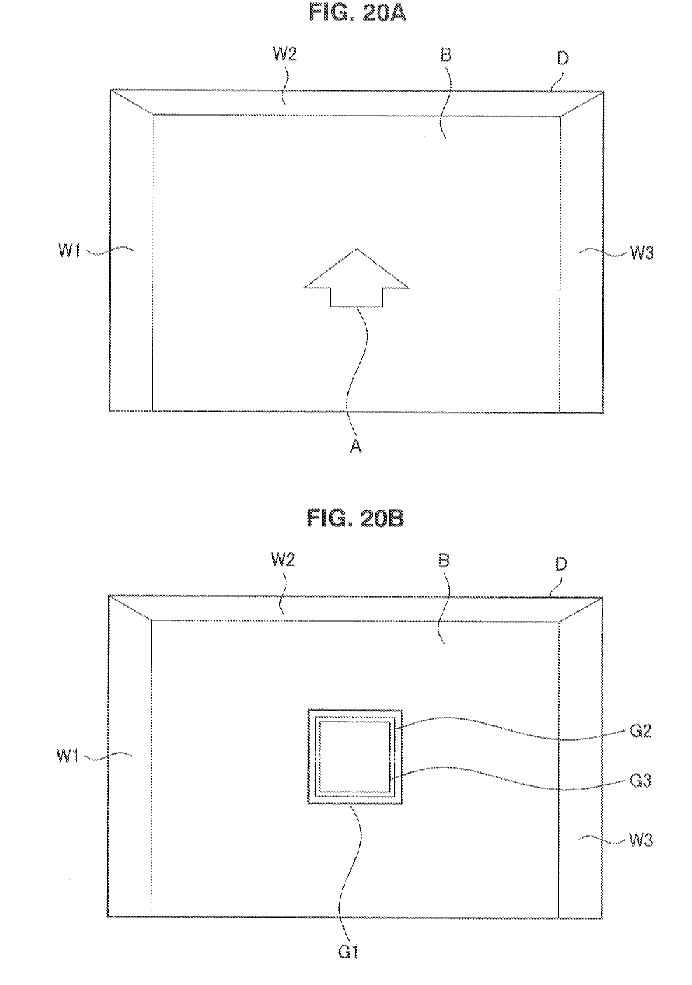

Similarly, FIGS. 18A and 18B show examples of viewpoint guidance objects displayed if the viewpoint position is wanted to be guided to the right side more than where it is presently, and FIGS. 19A and 19B show examples of viewpoint guidance objects displayed if the viewpoint position is wanted to be guided to the underside more than where it is presently. Also, FIGS. 20A and 20B show examples of viewpoint guidance objects displayed if the viewpoint position is wanted to be guided to the upside more than where it is presently.

As is clear from FIGS. 17A to 20B, by displaying such viewpoint guidance objects on the display screen, it becomes possible for the user to easily understand that the present viewpoint position is not included in the preferable viewpoint position range corresponding to the content. Furthermore, the user can easily understand in which direction the viewpoint should be moved by referring to such viewpoint guidance objects. Also, in the case of an arrow object like FIG. 17A is displayed as the viewpoint guidance object, by making the length of the arrow correspond to the size of the deviation amount, the movement amount of the viewpoint can be shown to the user, and thus user convenience can be further improved.

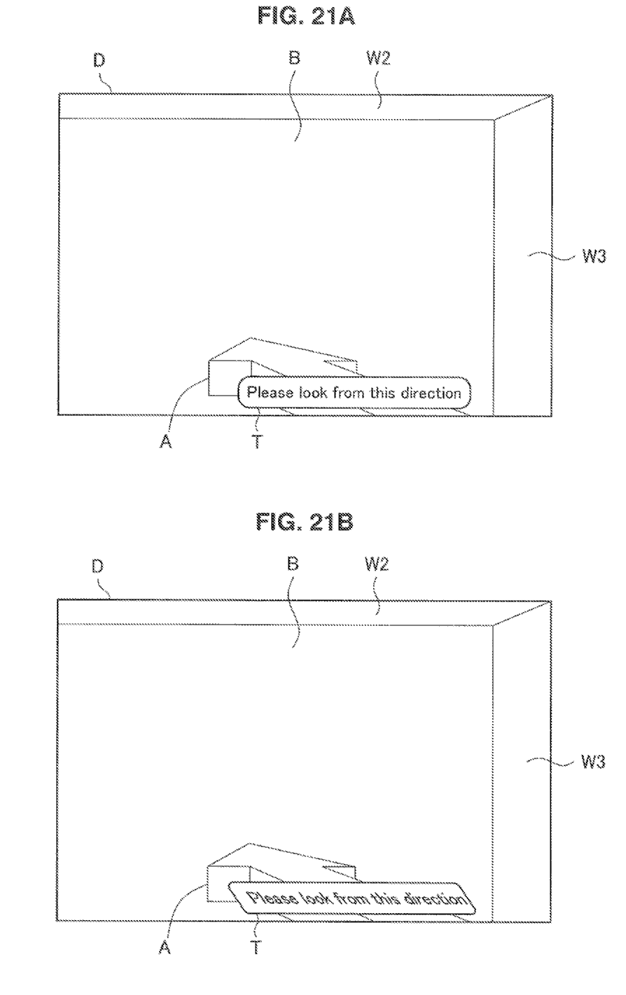

Also, the object display control unit 203 may, in addition to the viewpoint guidance objects, also display together text as shown in FIGS. 21A and 21B for guiding the user.

These viewpoint guidance objects disappear from the display screen if the viewpoint position of the user has entered into the viewpoint position range, and it becomes so that the content of the content is displayed. There are no particular limitations on the disappearance method of viewpoint guidance objects and text, and the viewpoint guidance objects may fade-out in accordance with fade-in of the content, or may instantaneously disappear from the display screen.

Also, if the viewpoint of the user once again deviates from the preferable viewpoint position range, viewpoint guidance objects may be displayed instead of the content.

Above, the display control process by the display control unit 115 according to the present embodiment was specifically explained with reference to FIGS. 16 to 21B.

### <Regarding the Flow of the Information Processing Method>

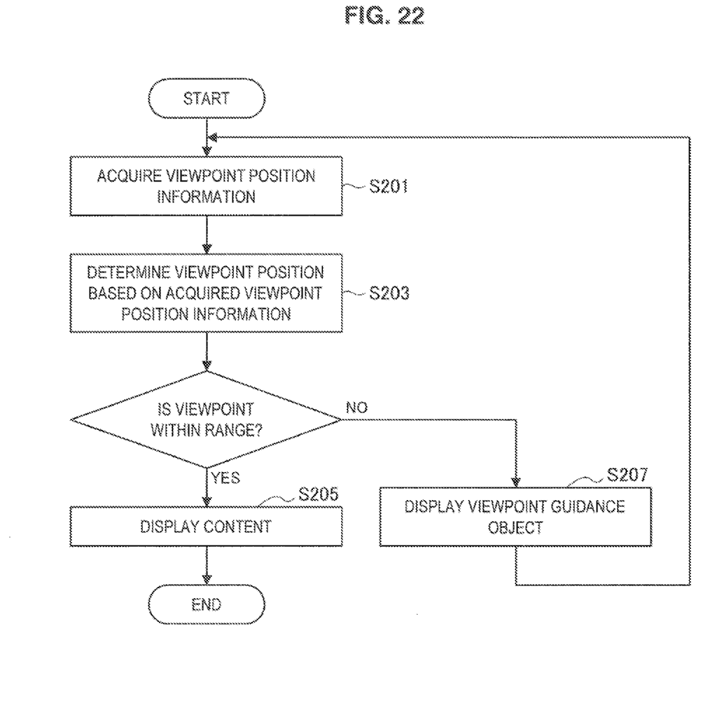

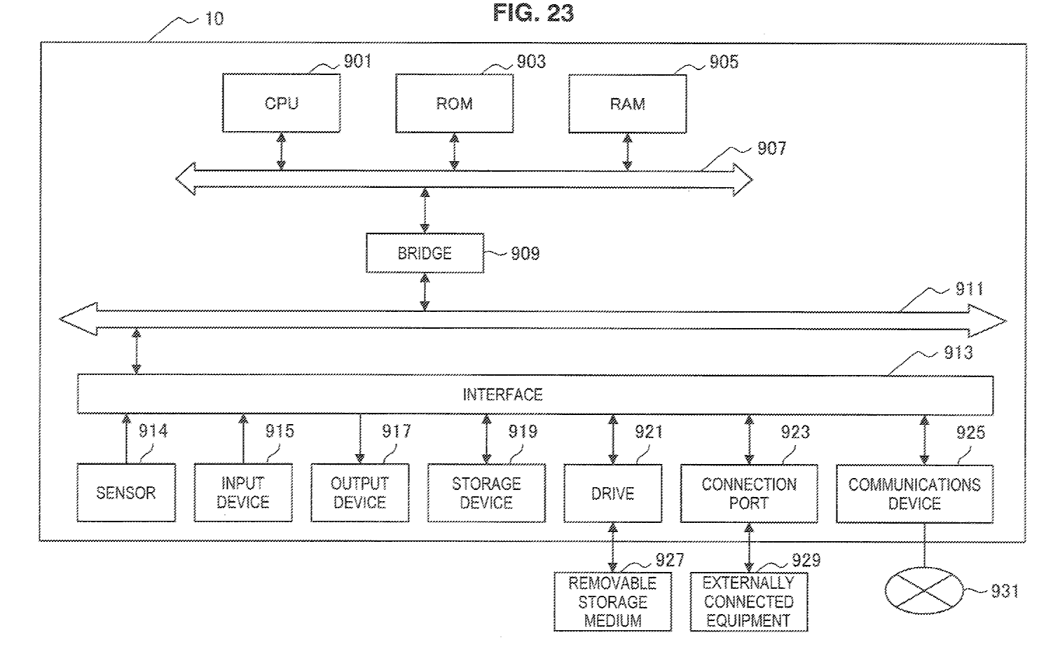

Next, regarding one example of the flow of the information processing method (that is, display control method) of the present embodiment is simply explained with reference to FIG. 22. FIG. 22 is a flowchart showing one example of the flow of the information processing method according to the present embodiment.

By the display control unit 115 according to the present embodiment, firstly, the viewpoint position determination unit 201 acquires viewpoint position information output from the user viewpoint position specification unit 113 (step S201), and based on the acquired viewpoint position information, determines whether the viewpoint position is included in the preferable viewpoint position range (step S203).

That is, if the viewpoint corresponding to the viewpoint position information is included in the preferable viewpoint position range, that fact is communicated to the content display control unit 205, and, under control by the content display control unit 205, content is displayed on the display screen (step S205).

On the other hand, if the viewpoint corresponding to the viewpoint position information is not included in the preferable viewpoint position range, that fact is communicated to the object display control unit 203, and, under control by the object display control unit 203, a viewpoint guidance object is displayed on the display screen (step S207). Thereafter, the display control unit 115 returns to step S201 and continues the process.

Above, regarding one example of the flow of the information processing method according to the present embodiment was simply explained with reference to FIG. 22.

As explained above, in the display control process according to the present embodiment, by associating a preferable viewing range with entity data of content as metadata for each content, the viewpoint of the user can be guided to a preferable view range without resort to content classification.

Also, by the display control process according to the present embodiment, viewpoint position adjustment by the user himself/herself becomes easier, and the load on the user is also small. Thereby, it becomes possible for the user to easily browse stereoscopic content, as well stereoscopic content for which the browsing method is somewhat advanced like phantogram or the like can be handled. As a result, it becomes easier to provide to the user enhanced content have a better stereoscopic effect, and it also becomes possible to reduce the load on the user at the time of browsing.

### (Regarding the Hardware Configuration)

Next, the hardware configuration of the information processing apparatus 10 according to the embodiments of the present disclosure will be described in detail with reference to FIG. 23. FIG. 23 is a block diagram for illustrating the hardware configuration of the information processing apparatus 10 according to the embodiments of the present disclosure.

The information processing apparatus 10 mainly includes a CPU 901, a ROM 903, and a RAM 905. Furthermore, the information processing apparatus 10 also includes a host bus 907, a bridge 909, an external bus 911, an interface 913, a sensor 914, an input device 915, an output device 917, a storage device 919, a drive 921, a connection port 923, and a communication device 925.

The CPU 901 serves as an arithmetic processing apparatus and a control device, and controls the overall operation or a part of the operation of the information processing apparatus 10 according to various programs recorded in the ROM 903, the RAM 905, the storage device 919, or a removable recording medium 927. The ROM 903 stores programs, operation parameters, and the like used by the CPU 901. The RAM 905 primarily stores programs that the CPU 901 uses and parameters and the like varying as appropriate during the execution of the programs. These are connected with each other via the host bus 907 configured from an internal bus such as a CPU bus or the like.

The host bus 907 is connected to the external bus 911 such as a PCI (Peripheral Component Interconnect/Interface) bus via the bridge 909.

The sensor 914 is a detection means such as a sensor that senses a motion of the user, and a sensor that acquires information representing a current position. As one example of such sensor, a three-axis acceleration sensor including an acceleration sensor, a gravity detection sensor, a fall detection sensor, and the like, a three-axis gyro sensor including an angular velocity sensor, a hand-blur compensation sensor, a geomagnetic sensor, and the like, or a GPS sensor, or the like can be listed. Further, the sensor 914 may be equipped with various measurement apparatuses other than the above described, such as a thermometer, an illuminometer, a hygrometer, or the like.

The input device 915 is an operation means operated by a user, such as a mouse, a keyboard, a touch panel, buttons, a switch and a lever. Also, the input device 915 may be a remote control means (a so-called remote control) using, for example, infrared light or other radio waves, or may be an externally connected apparatus 929 such as a mobile phone or a PDA conforming to the operation of the information processing apparatus 10. Furthermore, the input device 915 generates an input signal based on, for example, information which is input by a user with the above operation means, and is configured from an input control circuit for outputting the input signal to the CPU 901. The user of the information processing apparatus 10 can input various data to the information processing apparatus 10 and can instruct the information processing apparatus 10 to perform processing by operating this input apparatus 915.

The output device 917 is configured from a device capable of visually or audibly notifying acquired information to a user. Examples of such device include display devices such as a CRT display device, a liquid crystal display device, a plasma display device, an EL display device and lamps, audio output devices such as a speaker and a headphone, a printer, a mobile phone, a facsimile machine, and the like. For example, the output device 917 outputs a result obtained by various processes performed by the information processing apparatus 10. More specifically, the display device displays, in the form of texts or images, a result obtained by various processes performed by the information processing apparatus 10. On the other hand, the audio output device converts an audio signal such as reproduced audio data and sound data into an analog signal, and outputs the analog signal.

The storage device 919 is a device for storing data configured as an example of a storage unit of the information processing apparatus 10 and is used to store data. The storage device 919 is configured from, for example, a magnetic storage device such as a HDD (Hard Disk Drive), a semiconductor storage device, an optical storage device, or a magneto-optical storage device. This storage device 919 stores programs to be executed by the CPU 901, various data, and various data obtained from the outside.

The drive 921 is a reader/writer for recording medium, and is embedded in the information processing apparatus 10 or attached externally thereto. The drive 921 reads information recorded in the attached removable recording medium 927 such as a magnetic disk, an optical disk, a magneto-optical disk, or a semiconductor memory, and outputs the read information to the RAM 905. Furthermore, the drive 921 can write in the attached removable recording medium 927 such as a magnetic disk, an optical disk, a magneto-optical disk, or a semiconductor memory. The removable recording medium 927 is, for example, a DVD medium, an HD-DVD medium, or a Blu-ray medium. The removable recording medium 927 may be a CompactFlash (CF; registered trademark), a flash memory, an SD memory card (Secure Digital Memory Card), or the like. Alternatively, the removable recording medium 927 may be, for example, an IC card (Integrated Circuit Card) equipped with a non-contact IC chip or an electronic appliance.

The connection port 923 is a port for allowing devices to directly connect to the information processing apparatus 10. Examples of the connection port 923 include a USB (Universal Serial Bus) port, an IEEE1394 port, a SCSI (Small Computer System Interface) port, and the like. Other examples of the connection port 923 include an RS-232C port, an optical audio terminal, an HDMI (High-Definition Multimedia Interface) port, and the like. By the externally connected apparatus 929 connecting to this connection port 923, the information processing apparatus 10 directly obtains various data from the externally connected apparatus 929 and provides various data to the externally connected apparatus 929.

The communication device 925 is a communication interface configured from, for example, a communication device for connecting to a communication network 931. The communication device 925 is, for example, a wired or wireless LAN (Local Area Network), Bluetooth (registered trademark), a communication card for WUSB (Wireless USB), or the like. Alternatively, the communication device 925 may be a router for optical communication, a router for ADSL (Asymmetric Digital Subscriber Line), a modem for various communications, or the like. This communication device 925 can transmit and receive signals and the like in accordance with a predetermined protocol such as TCP/IP on the Internet and with other communication devices, for example. The communication network 931 connected to the communication device 925 is configured from a network and the like, which is connected via wire or wirelessly, and may be, for example, the Internet, a home LAN, infrared communication, radio wave communication, satellite communication, or the like.

Heretofore, an example of the hardware configuration capable of realizing the functions of the information processing apparatus 10 according to the embodiment of the present disclosure has been shown. Each of the structural elements described above may be configured using a general-purpose material, or may be configured from hardware dedicated to the function of each structural element. Accordingly, the hardware configuration to be used can be changed as appropriate according to the technical level at the time of carrying out the present embodiment.

Although the preferred embodiments of the present invention have been in explained in detail above with reference to the accompanying drawings, the technical scope of the present disclosure is not limited to these examples. It is clear that a person having normal knowledge in the technical field of the present disclosure can conceive of various altered examples or modified examples within the scope of the technical idea describe in the claims, and it should be understood that these also will naturally come under the technical scope of the present disclosure.

(1)

An information processing apparatus including:

a viewpoint position determination unit that determines, based on acquired viewpoint position information regarding a viewpoint position of a user, whether the viewpoint position of the user is included in a viewpoint position range suitable for content; and

an object display control unit that, if the viewpoint position of the user is not included in the viewpoint position range suitable for the content, performs display control for displaying a viewpoint guidance object that guides the viewpoint of the user to the viewpoint position range suitable for the content.

(2)

The information processing apparatus according to (1), wherein the object display control unit changes display of the viewpoint guidance object according to a transition in time of the viewpoint position of the user corresponding to the viewpoint position information.

(3)

The information processing apparatus according to (2), further including:

a content display control unit configured to control display of the content,

wherein the content display control unit does not execute display control of the content during display of the viewpoint guidance object, and

wherein, if the viewpoint position of the user becomes so as to be included in the viewpoint position range suitable for the content, the object display control unit does not display the viewpoint guidance object and the content display control unit starts control display of the content.

(4)

The information processing apparatus according to (3), wherein the object display control unit displays text for guiding the user together with the viewpoint guidance object.

(5)

The information processing apparatus according to any one of (1) to (4), wherein the content is stereoscopic content for which a stereoscopic feel is enhanced when the user views from a given viewpoint position range.

(6)

An information processing method including:

determining, based on acquired viewpoint position information regarding a viewpoint position of a user, whether the viewpoint position of the user is included in a viewpoint position range suitable for content; and

if the viewpoint position of the user is not included in the viewpoint position range suitable for the content, performing display control for displaying a viewpoint position guidance object that guides the viewpoint of the user to the viewpoint position range suitable for the content.

(7)

A program for causing a computer to realize:

a viewpoint position determination function that determines, based on acquired viewpoint position information regarding a viewpoint position of a user, whether the viewpoint position of the user is included in a viewpoint position range suitable for content; and

an object display control function that, if the viewpoint position of the user is not included in the viewpoint position range suitable for the content, performs display control for displaying a viewpoint position guidance object that guides the viewpoint of the user to the viewpoint position range suitable for the content.

### REFERENCE SIGNS LIST

10 information processing apparatus
101 control unit
103 sensor
105 storage unit
107 imaging unit
111 integrated control unit
113 user viewpoint position specification unit
115 display control unit
151 sensor information acquisition unit
153 picked up image acquisition unit
155 sensor information analysis unit
157 viewpoint position estimation unit
201 viewpoint position detection unit
203 object display control unit
205 content display control unit

1. An information processing apparatus comprising:
a viewpoint position determination unit that determines, based on acquired viewpoint position information regarding a viewpoint position of a user, whether the viewpoint position of the user is included in a viewpoint position range suitable for content; and
an object display control unit that, if the viewpoint position of the user is not included in the viewpoint position range suitable for the content, performs display control for displaying a viewpoint guidance object that guides the viewpoint of the user to the viewpoint position range suitable for the content.

2. The information processing apparatus according to claim 1, wherein the object display control unit changes display of the viewpoint guidance object according to a transition in time of the viewpoint position of the user corresponding to the viewpoint position information.

3. The information processing apparatus according to claim 2, further comprising:
a content display control unit configured to control display of the content,
wherein the content display control unit does not execute display control of the content during display of the viewpoint guidance object, and
wherein, if the viewpoint position of the user becomes so as to be included in the viewpoint position range suitable for the content, the object display control unit does not display the viewpoint guidance object and the content display control unit starts control display of the content.

4. The information processing apparatus according to claim 3, wherein the object display control unit displays text for guiding the user together with the viewpoint guidance object.

5. The information processing apparatus according to claim 1, wherein the content is stereoscopic content for which a stereoscopic feel is enhanced when the user views from a given viewpoint position range.

6. An information processing method comprising:
determining, based on acquired viewpoint position information regarding a viewpoint position of a user, whether the viewpoint position of the user is included in a viewpoint position range suitable for content; and
if the viewpoint position of the user is not included in the viewpoint position range suitable for the content, performing display control for displaying a viewpoint position guidance object that guides the viewpoint of the user to the viewpoint position range suitable for the content.

7. A program for causing a computer to realize:
a viewpoint position determination function that determines, based on acquired viewpoint position information regarding a viewpoint position of a user, whether the viewpoint position of the user is included in a viewpoint position range suitable for content; and
an object display control function that, if the viewpoint position of the user is not included in the viewpoint position range suitable for the content, performs display control for displaying a viewpoint position guidance object that guides the viewpoint of the user to the viewpoint position range suitable for the content.
